(19) United States
(12) Patent Application Publication
(10) Pub. No.: US 2008/0290633 A1
(43) Pub. Date: Nov. 27, 2008

(54) Restraint System

(75) Inventors: Werner Bacher, Sindelfingen (DE); Walter Eberle, Hochdorf (DE); Christian Goetz, Plochingen (DE); Till Heinrich, Esslingen (DE); Simon Kramer, Schorndorf (DE); Martin Lanzerath, Denkendorf (DE); Albert Reitinger, Berglen (DE); Julien Richert, Bad Cannstatt (DE); Clark Ruedebusch, Holzgerlingen (DE); Matthias Struck, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/994,091

(22) PCT Filed: Jun. 30, 2006
(86) PCT No.: PCT/EP2006/006341

§ 371 Date: Jun. 4, 2008

(30) Foreign Application Priority Data
Jul. 2, 2005 (DE) 20 2005 012 944.5
Sep. 14, 2005 (DE) 10 2005 043 706.0

(51) Int. Cl. B60R 21/16

(52) U.S. Cl. 280/728.1

(57) ABSTRACT

A passenger vehicle restraint system that is capable of being placed in different positions, consisting of an interior defined by a housing and at least one airbag, at least one gas generator for delivering gas to the interior in order to inflate the airbag, at least one controllable outlet provided on the housing which may be closed by a closing element, such that an internal pressure in the interior may be adjusted according to parameters relevant to passenger load during an accident. A restraint system, which is easy to construct and can be manufactured cost-effectively, is provided by an adjustable stop element limiting the opening movement of the closing element, which is coupled to the vehicle seat such that the stop element is displaced according to parameters relevant to passenger load, in order to adjust the outlet cross section defined by the closing element located in its closed position.

This application is a national stage of PCT International Application No. PCT/EP2006/006341, filed Jun. 30, 2006, which claims priority under 35 U.S.C. § 119 to German Patent Application No. 20 2005 012 944.5, filed Jul. 2, 2005, and German Patent Application No. 10 2005 043 706.0, filed Sep. 14, 2005, the disclosures of which are expressly incorporated by reference herein.

### BACKGROUND AND SUMMARY OF THE INVENTION

The invention relates to a restraint system for a passenger of a vehicle which may be placed in different positions and includes an interior which is defined by a housing, at least one airbag, at least one gas generator for delivering gas to the interior in order to inflate the airbag, gas being able to be discharged from the interior via at least one controllable outlet provided on the housing which may be closed by a closing element movable from a closed position into an open position, such that an internal pressure in the interior may be adjusted according to parameters relevant to passenger load during an accident.

A restraint system for a passenger of a vehicle is known from the German published patent application DE 101 24 273 A1, including an interior which is defined by a housing, at least one airbag, and at least one gas generator for delivering gas to the interior in order to inflate the airbag. For improving the safety of the passenger, gas may be discharged from the interior via at least one controllable outlet, such that during an accident event an internal pressure is adjusted in the interior according to parameters relevant to passenger load. For controlling the outlet, at least one control device is provided with a closure member arranged on the outlet.

An airbag module outlet comprising a ventilation member is known from the German published patent application DE 10 2004 027 703 A1, which may be moved between an open state, which allows the flow of inflation fluid through a ventilation opening, and a closed state which blocks at least partially the flow of inflation fluid through the ventilation opening.

A method for operating an airbag module is known from the German published patent application DE 103 40 910 A1, in which a defined opening is actively adjusted by restricting the flow cross-section of an air intake aperture.

A safety device comprising a housing wall is known from the German published patent application DE 41 33 506 A1, in which an outlet is provided with an effective cross sectional area which may be altered.

A protective device comprising a closed passage for the discharge of cooling gases from an airbag is known from the German utility model DE 299 07 607 U1, the cross section thereof being able to be fully or partially opened after activating the device.

Gas generators with a gas flow which may be regulated are known from the European patent application EP 0 745 517 A1 and the U.S. Pat. No. 5,366,242.

Further restraint systems are known from the German published patent application DE 100 20 795 A1 and the German patent DE 197 49 780 C2.

A safety device for motor vehicles is known from the German published patent application DE 44 21 814 A1.

One object of the invention is to provide a restraint system for a passenger of a vehicle which is of simple construction and which may be produced cost-effectively.

This and other objects are achieved in a restraint system for a passenger of a vehicle which may be placed in different positions, and includes an interior which is defined by a housing, at least one airbag, at least one gas generator for delivering gas to the interior in order to inflate the airbag, gas being able to be discharged from the interior via at least one controllable outlet provided on the housing, on the gas generator or on the airbag itself. The outlet may be closed by a closing element movable from a closed position into an open position, such that an internal pressure in the interior may be adjusted according to parameters relevant to passenger load during an accident, by an adjustable stop element limiting the opening movement of the closing element. The closing element is displaced according to parameters relevant to passenger load, in order to adjust the outlet cross section which is defined by the closing element located in its closed position.

The amount of gas flow escaping from the interior during an accident may easily be adapted, for example, to the vehicle seat position in the longitudinal direction of the vehicle. The cross section of the outlet is automatically determined by the adjustable stop element according to parameters relevant to passenger load. Such parameters relevant to passenger load are to be understood within the context of the invention to mean all parameters which have an influence on the loads of a passenger in the case of an accident. Examples which may be mentioned here are the weight or the size of the passenger, the position of the vehicle seat or the position of the passenger on the vehicle seat.

A preferred embodiment of the restraint system is characterized in that the closing element is formed by a slide. The slide is preferably designed such that it closes a plurality of outlets simultaneously in its closed position, which it opens in its open position. Another embodiment of the system is a flap in place of the slide.

An additional embodiment of the restraint system is characterized by a stop element coupled to the vehicle seat by means of a Bowden cable, in particular a control cable. Preferably, a Bowden cable, two oppositely running Bowden cables or one Bowden cable with retention springs may be used which are attached to a seat rail of the vehicle seat. A mechanical coupling between the size of the outlet and the position of the vehicle seat may thus be produced in a simple manner.

In one particular embodiment, the restraint system is characterized by the stop element being coupled to the vehicle seat by the interposition of a gear mechanism, in particular a step-down gearing. By means of the gear mechanism, for example, a vehicle seat adjusting path of 30 cm is converted into a stop element adjusting path of 2 cm.

Further preferred embodiments of the restraint system are characterized by the coupling of the stop element to the vehicle seat such that the outlet cross section is associated with the vehicle seat position in a linear, non-linear or restricted linear manner. The outlet cross section can be opened in stages depending on the vehicle seat position and parameters relevant to passenger load.

It is also conceivable for the outlet area, or the outlet volume, to be adjusted by means of an actuator, for example an electric motor, depending on the detected seat position, passenger position, passenger weight, seatbelt engagement status or severity of the accident. A mechanical coupling between the vehicle seat and stop element would therefore not be necessary.

A second stop element may define the opening movement of the closing element that cooperates with a seatbelt buckle switch to adjust the outlet cross section, which is defined by the closing element located in its closed position. Preferably, the second stop element is given precedence, independently of the first stop element and/or outlet cross section. It is possible to monitor via the seatbelt buckle switch when the passenger is wearing a seat belt. If the passenger is not wearing a seat belt, the airbag has to be firmer as it then represents the only restraint means. For example, a second stop for the closing element may be defined by means of a magnet which ensures that the closing element does not open at all or only opens slightly.

A further preferred embodiment of the restraint system is characterized in that the second stop element includes a magnet. By means of the magnet, the duration of the closing element in the region of the stop may be prolonged.

The closing element may also be moved from its closed position into its open position by means of a pyrotechnic device, when the restraint system is activated. The pyrotechnic device is triggered according to the severity of the accident, the weight and/or the posture of the passenger and the seatbelt status, amongst others. For these reasons, a defined switching time is calculated, for example, a time period during which the pyrotechnic device is activated and the closing element is moved or released.

A further exemplary embodiment of the restraint system is characterized in that the closing element can be opened by means of the gas pressure of the gas generator or of the second gas generator stage. This embodiment describes a so-called self-opening variant, for example, a high internal gas pressure in the interior of the restraint system. The closing element is moved by the gas pressure from its closed position into its open position. In the case of relatively light passengers, the closing element is moved forward relatively close to the outlet of the airbag, for high internal pressure to be quickly dissipated so that a relatively soft airbag is provided.

Since the airbag cover on the instrument panel or in the steering wheel requires a relatively high pressure for opening, the closing element should first be moved when the airbag cover is completely open. In order to prevent an early pressure loss through the outlets on the housing opened by the closing element, the outlets are first opened after the opening of the airbag cover.

One embodiment of the airbag cover on the instrument panel is a mechanism between the airbag cover and the closing element. The closing element could for example be locked by means of traction elements such as belts or cables which are attached to the airbag cover. The pivoting-open of the airbag cover shortens the traction element, so that the locking action is released and the outlet is opened.

In addition to the variable outlet, the airbag has a constant outlet as well. In this way, a constant proportion of gas can escape from the airbag, while a variable proportion can escape via the variable outlet on the housing. This can be obtained by means of a corresponding gas permeability of the airbag.

Other objects, advantages and novel features of the present invention will become apparent from the following detailed description of the invention when considered in conjunction with the accompanying diagrams.

### BRIEF DESCRIPTION OF THE DRAWINGS

FIG. 1 shows a perspective view of a detail of a restraint system according to the invention with the outlets closed;

FIG. 2 shows the restraint system of FIG. 1 with the outlets open,

FIG. 3 shows a Cartesian coordinate system in which the size of the outlet is plotted over the longitudinal position of a vehicle seat,

FIG. 4 shows a schematic view of a restraint system according to the invention with a further outlet in the airbag,

FIG. 5a shows a coordinate system in which the relationship between seat position/passenger position and airbag volume is illustrated,

FIG. 5b shows a coordinate system in which the relationship between seat position/passenger position and airbag volume/airbag propagation is illustrated,

FIG. 6 shows a coordinate system in which the relationship between seat position/passenger position and outlet is illustrated,

FIG. 7 shows a coordinate system in which the relationship between seat belt status and outlet is illustrated,

FIG. 8 shows a coordinate system in which the relationship between passenger weight and outlet is illustrated,

FIG. 9 shows a coordinate system in which the relationship between seat position and airbag internal pressure is illustrated depending on passenger weight and severity of the crash,

FIG. 10 shows a perspective view of a restraint system according to the invention in a further embodiment,

FIG. 11a shows a side view of the embodiment as per FIG. 10, and

FIG. 11b shows a plan view of the embodiment as per FIG. 10.

### DETAILED DESCRIPTION OF THE DRAWINGS

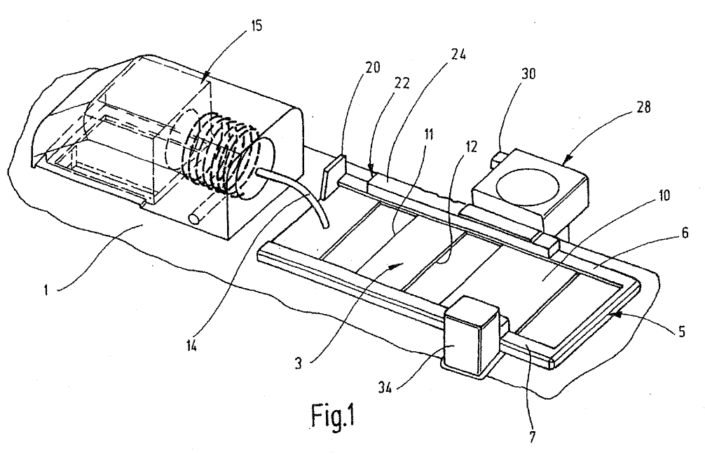

FIG. 1 shows a detail of a restraint system, which includes a housing 1 with a slide 3. A U-shaped frame 5 is fastened to the housing 1 which has two guide rails 6, 7 which are arranged parallel to one another and in which the slide 3 is guided in the longitudinal direction of the guide rails 6, 7.

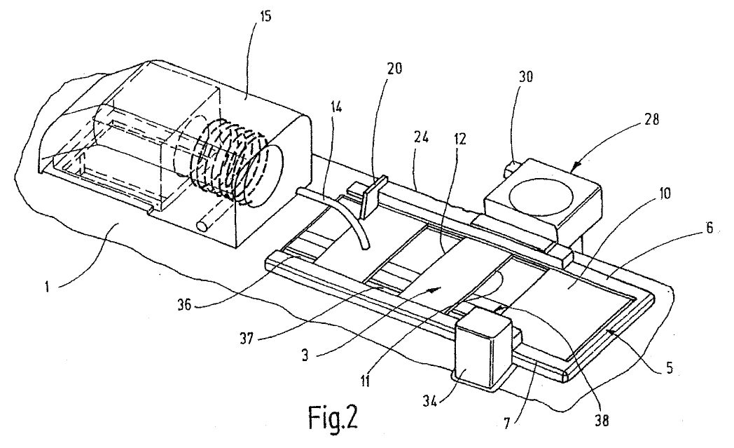

The slide 3 has the form of a rectangular plate 10 which has two rectangular openings 11, 12. In the region of one end of the slide 3, a curved actuating finger 14, which may be configured to be deformable, extends from the rectangular plate 10. The free end of the actuating finger 14 is oriented toward a piston housing 15. In the piston housing 15 a pyrotechnic device is received, by means of which the slide 3 is moved via the actuating finger 14 from its closed position shown in FIG. 1 into its open position shown in FIG. 2. The pyrotechnic device is secured against overpressure since it must be ensured that the stop rail 24 may not be displaced by the pyrotechnic device.

A stop lug 20 which projects at right angles from the rectangular plate 10 and may be deformable is fastened to the end facing piston housing 15 of the rectangular plate 10 of the slide 3. The stop lug 20 is arranged in the closed position of the slide 3 at a distance from a stop surface 22 which is provided at one end of a stop rail 24. The stop rail 24 may be moved by means of a step-down gearing 28 relative to the housing and the U-shaped frame 5. The step-down gearing 28 has a receiver 30 for one end of a Bowden cable (not shown), the other end thereof being fastened to a vehicle seat. In the case of an electric drive, the receiver 30 is designed for a corresponding drive.

In FIG. 2 the slide 3 is located in its open position. In the open position, the slide 3 opens three outlets 36 to 38, which are provided in the housing 1. The number of outlets may be freely chosen, although at least one is necessary. In the open position of the slide 3, the stop lug 20 bears against the stop surface (22 in FIG. 1) of the stop rail 24. Thus the size of the opening cross section of the outlets 36 to 38 opened by the slide 3 is determined by the stop rail 24. The stop rail 24 is, in turn, moved by means of the step-down gearing 28 in the longitudinal direction of the guide rail 6 via the Bowden cable coupled to the vehicle seat, when the vehicle seat is adjusted. Thus the size of the outlets is adjusted by the longitudinal position of the seat. The Bowden cable is preferably attached to a seat rail and forms a direct connection for controlling the outlet cross section.

It may be also possible to monitor whether the passenger is wearing a seat belt via a seatbelt buckle switch 34. If the passenger is not wearing a seat belt, the airbag has to be firmer as it is used as the only restraint means. For example, a second stop for the slide may be defined by using a magnet, which ensures that the slide does not open at all or only opens slightly. Moreover, a new cross section is defined which should always be effective when the passenger is not wearing a seat belt. A magnet may be used which prolongs the duration of the slide in the region of the stop.

According to an essential aspect of the present invention, the longitudinal position of the seat determines the size of the outlet cross section in the opened state of the slide. When the passenger, for example a small person, adopts a seating position toward the front, the stop element is displaced such that the slide opens as much area of the opening cross section as possible. When the passenger, for example a large person, adopts a seating position toward the rear, the stop element, in particular the stop rail, is displaced such that the slide covers as much area of the opening cross section as possible. As a result, it is ensured that with a small person the airbag is soft and with a large person the airbag is as firm as possible. According to the vehicle conditions, a linear or non-linear control of the outlet cross section is possible depending on the longitudinal position of the seat.

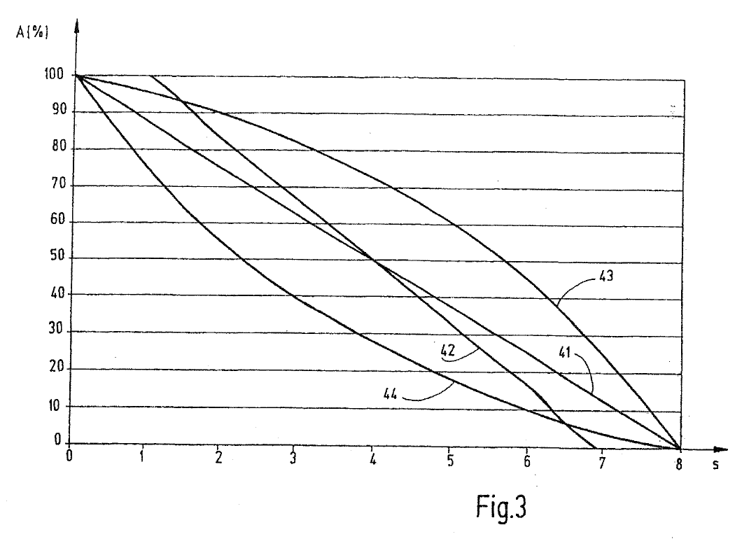

In FIG. 3, a Cartesian coordinate diagram is shown in which the controllable outlet cross section A is plotted as a percentage over the longitudinal position of the seat or passenger position S. At zero, the vehicle seat is in its front position and at eight it is in its rear end position. A linear connection is denoted at 41 and a limited linear connection is denoted at 42 between the outlet cross section and the longitudinal position of the seat. Two non-linear connections between the outlet cross section A and the longitudinal position of the seat S are denoted as 43 and 44.

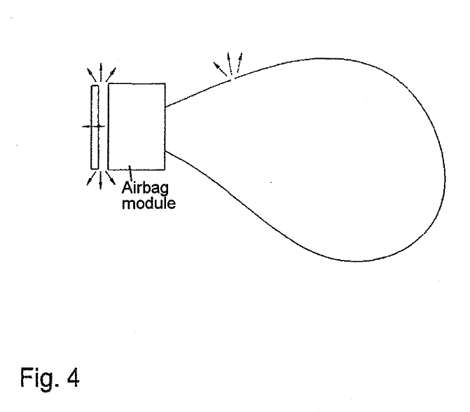

FIG. 4 shows the restraint system according to the invention with a further outlet 50 in an airbag 51. The housing 1 with the movable slide 3 is shown merely schematically. With the combination of a switchable and a constant outlet, it is possible to represent yet more loading cases.

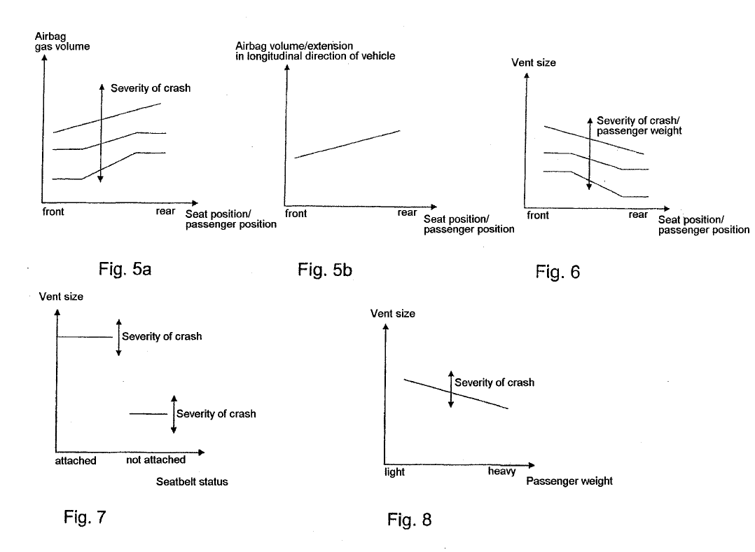

FIGS. 5 to 9 all show relationships between selected parameters relevant to passenger load and the safety device according to the invention.

For example, it can be seen from the illustration in FIG. 5 that, with increasing distance between the seat and the outlet of the airbag in the instrument panel or in the steering wheel, the airbag volume increases. This is regulated by means of the outlet on the housing or on the gas generator which is adjusted so as to have a larger or smaller area depending on the position of the seat. As shown in FIG. 6, it is necessary for this purpose, in the case of a seat position far forward, for the outlet to be kept large, while in the case of a rear seat position, the outlet is very small or completely closed.

A similar relationship can be produced between the seatbelt engagement status and the outlet, as shown in FIG. 7. If the seat belt is not engaged, then a small outlet should be given, since the airbag is then the only means of restraint.

According to FIG. 8, the outlet decreases with increasing passenger weight.

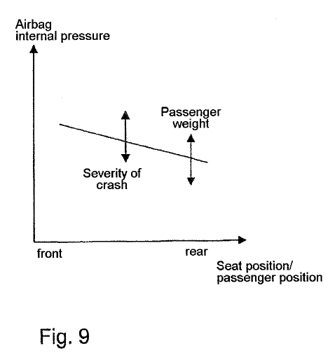

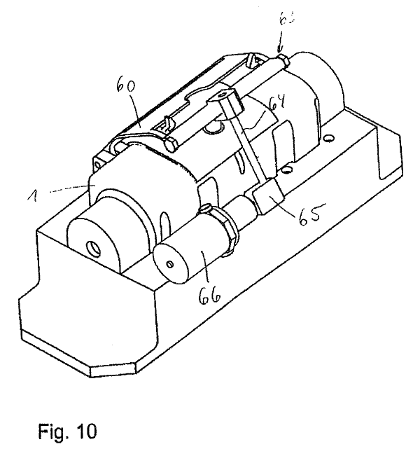

The airbag internal pressure decreases with increasing distance between the outlet of the airbag and the seat position, since the unfolding airbag covers a larger distance before the passenger is intercepted (FIG. 9).

With the restraint system according to the invention, the airbag internal pressure, the damping, and the airbag volume can be influenced, specifically either with mechanical coupling between the outlet and the position of the vehicle seat or with coupling between the outlet and an actuator which is adjusted corresponding to the sensed data relevant to passenger load.

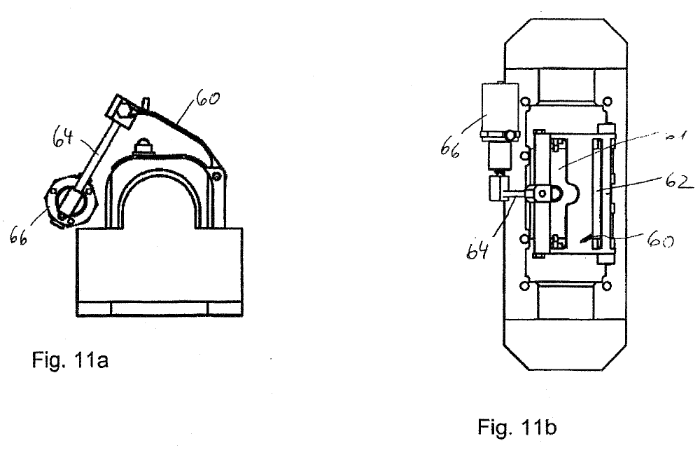

FIG. 10 shows a perspective view of a restraint system in a further embodiment. The same reference symbols denote identical components to the preceding embodiment. Instead of the slide, the restraint system has a flap 60 which has cutouts 61 and 62. Fastened to the free end 63 of the flap 60 is an actuating finger 64. The end 65 which is situated opposite the latter is coupled to the drive output of a drive device 66, by means of which the flap 60 is moved, by means of the actuating finger 64, from its position illustrated in FIG. 10 into its position illustrated in FIG. 11b and 11a.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-18. (canceled)

19. A restraint system for a passenger of a vehicle which may be placed in different positions, comprising:
an interior which is defined by a housing and at least one airbag, at least one gas generator for delivering gas to the interior for airbag inflation, gas able to be discharged from the interior via at least one controllable outlet which may be closed by an element movable from a closed position into an open position,
such that an internal pressure in the interior may be adjusted according to parameters relevant to passenger load during an accident,
characterized by an adjustable stop element limiting the opening movement of the closing element, which may be displaced according to parameters relevant to passenger load, in order to adjust the outlet cross section which is defined by the closing element located in its closed position.

20. The restraint system as claimed in claim 19, characterized in that the closing element is formed by a slide.

21. The restraint system as claimed in claim 19, characterized in that the closing element is formed by a flap.

22. The restraint system as claimed in claim 19, characterized in that the stop element is coupled to the vehicle seat by means of at least one of a Bowden cable, a double Bowden cable and a Bowden cable with return spring.

23. The restraint system as claimed in claim 20, characterized in that the stop element is coupled to the vehicle seat by means of at least one of a Bowden cable, a double Bowden cable and a Bowden cable with return spring.

24. The restraint system as claimed in claim 21, characterized in that the stop element is coupled to the vehicle seat by means of at least one of a Bowden cable, a double Bowden cable and a Bowden cable with return spring.

25. The restraint system as claimed in claim 19, characterized in that the stop element is coupled to the vehicle seat by the interposition of a gear mechanism, in particular a step-down gearing.

26. The restraint system as claimed in claim 19, characterized in that the stop element is coupled to the vehicle seat such that the outlet cross section is associated with the vehicle seat position in a linear manner.

27. The restraint system as claimed in claim 19, characterized in that the stop element is coupled to the vehicle seat such that the outlet cross section is associated with the vehicle seat position in a non-linear manner.

28. The restraint system as claimed in claim 19, characterized in that the stop element is coupled to the vehicle seat such that the outlet cross section is associated with the vehicle seat position in a restricted linear manner.

29. The restraint system as claimed in claim 19, characterized in that the stop element is coupled to the vehicle seat such that the outlet cross section is opened in stages depending on the vehicle seat position and parameters relevant to passenger load.

30. The restraint system as claimed in claim 19, characterized in that the stop element can be adjusted by means of an actuator which can be controlled corresponding to the detected parameters relevant to passenger load.

31. The restraint system as claimed in claim 19, characterized in that a second stop element defining the opening movement of the closing element cooperates with a seatbelt buckle switch, in order to adjust the outlet cross section, which is defined by the closing element located in its closed position.

32. The restraint system as claimed in claim 31, characterized in that the second stop element comprises a magnet.

33. The restraint system as claimed in claim 19, characterized in that the closing element is moved from its closed position into its open position by means of a pyrotechnic device, after a time relevant to passenger load after activation of the restraint system.

34. The restraint system as claimed in claim 33, characterized in that the activation of the pyrotechnic device is dependent on the evaluation of the parameters: severity of the accident and/or passenger weight and/or passenger posture and/or seat belt status.

35. The restraint system as claimed in claim 19, characterized in that the closing element can be actuated by means of the gas pressure of the gas generator and/or of the first gas generator stage and/or of the second gas generator stage.

36. The restraint system as claimed in claim 19, characterized in that a movement of the closing element takes place after the opening of the airbag cover.

37. The restraint system as claimed in claim 19, characterized in that at least one outlet is provided in the airbag.

38. The restraint system as claimed in claim 19, characterized in that, in the case of a two-stage gas generator, the outlet is first switched with the ignition of the second stage.
